(19) United States
(12) Patent Application Publication
(10) Pub. No.: US 2026/0010353 A1
(43) Pub. Date: Jan. 8, 2026

(54) CODE VERIFICATION AND ATTRIBUTION USING SEMANTIC ANALYSIS

(71) Applicant: INTERNATIONAL BUSINESS MACHINES CORPORATION, Armonk, NY (US)

(72) Inventors: Gennaro Anthony Cuomo, Raleigh, NC (US); Lucia Larise Stavarache, Columbus, OH (US); Blaine H. Dolph, Western Springs, IL (US); Trent A. Gray-Donald, Ottawa (CA)

(21) Appl. No.: 18/762,985

(22) Filed: Jul. 3, 2024

(51) Int. Cl. G06F 8/41; G06F 40/30

(52) U.S. Cl. CPC G06F 8/42; G06F 8/4435; G06F 40/30

(57) ABSTRACT

Systems and methods are provided for attributing source code, including ingesting source code from a plurality of repositories, normalizing the ingested source code using abstract syntax trees (ASTs), and converting the normalized source code into vector embeddings that represent syntactic and semantic features of the source code. Unique fingerprints are generated from the vector embeddings, the fingerprints are compared against a vector database to identify potential matches and verify code attribution, and feedback and alternative code suggestions are provided based on the comparing the fingerprints.

### BACKGROUND

The present invention generally relates to systems and methods for processing and analyzing source code, and more particularly to systems and methods for identifying and attributing source code using abstract syntax trees (ASTs), vector embeddings, and graph neural networks (GNNs) to determine coding patterns and authorship, verify code originality, provide feedback and perform automatic corrective actions for enhancing code quality and maintainability.

In the field of source code attribution and verification, traditional methods have relied on syntactic analysis and direct code comparison techniques to identify and attribute source code. These approaches focus on surface-level features such as text similarity, token matching, and simple syntactic patterns. While effective in some limited contexts, these methods face significant limitations when applied to comparatively more complex scenarios involving, for example, nuanced coding styles, mixed human and AI-generated code, and cross-language codebases. Conventional systems and methods struggle with accurately identifying and attributing code that has been obfuscated, heavily modified, or written in different programming languages. Additionally, the reliance on predefined rules and static datasets by such conventional systems and methods poses significant challenges in scalability and adaptability, which will only increase as coding practices and languages evolve and become more complex over time. Conventional systems and methods also fall short in providing actionable feedback for developers and implanting any automatic corrective actions to improve code robustness and maintainability. These limitations highlight the need for advanced, dynamic, and scalable solutions capable of performing deep semantic analysis and offering practical insights across diverse and evolving codebases.

### SUMMARY

In accordance with an embodiment of the present invention, a method is provided for for attributing source code, including ingesting source code from a plurality of repositories, normalizing the ingested source code using abstract syntax trees (ASTs), and converting the normalized source code into vector embeddings that represent syntactic and semantic features of the source code. Unique fingerprints are generated from the vector embeddings, the fingerprints are compared against a vector database to identify potential matches and verify code attribution, and feedback and alternative code suggestions are provided based on the comparing the fingerprints.

According to additional embodiments of the present invention, the method further includes analyzing the fingerprints using graph neural networks (GNNs) to detect coding patterns and authorship attributes, removing comments and dead code during the normalizing the ingested source code, wherein the ingestion of source code includes collecting code from both public and private repositories, generating vector embeddings using a neural network model trained on a large corpus of code, generating a report that summarizes results of the attributing the source code, including specific confidence levels for the code attribution, performing robustness testing by creating and evaluating multiple code variants to ensure attribution accuracy under different code modifications, and providing feedback and alternative code suggestions includes recommending best practices for code maintainability and security.

According to another aspect of the present invention, a system is provided for attributing source code, including ingesting source code from a plurality of repositories, normalizing the ingested source code using abstract syntax trees (ASTs), and converting the normalized source code into vector embeddings that represent syntactic and semantic features of the source code. Unique fingerprints are generated from the vector embeddings, the fingerprints are compared against a vector database to identify potential matches and verify code attribution, and feedback and alternative code suggestions are provided based on the comparing the fingerprints.

According to additional embodiments of the present invention, the system includes a memory storing instructions to analyze the fingerprints using graph neural networks (GNNs) to detect coding patterns and authorship attributes, to remove comments and dead code during the normalizing the ingested source code, and the ingestion of source code includes collecting code from both public and private repositories, generate the vector embeddings using a neural network model trained on a large corpus of code, generate a report that summarizes results of the attributing the source code, including specific confidence levels for the code attribution, perform robustness testing by creating and evaluating multiple code variants to ensure attribution accuracy under different code modifications, and the recommendations for best practices in code maintainability and security in the feedback and alternative code suggestions provided by the system.

According to another aspect of the present invention, a computer program product is provided for attributing source code, including ingesting source code from a plurality of repositories, normalizing the ingested source code using abstract syntax trees (ASTs), and converting the normalized source code into vector embeddings that represent syntactic and semantic features of the source code. Unique fingerprints are generated from the vector embeddings, the fingerprints are compared against a vector database to identify potential matches and verify code attribution, and feedback and alternative code suggestions are provided based on the comparing the fingerprints.

According to additional embodiments of the present invention, the computer program product includes program instructions to analyze the fingerprints using graph neural networks (GNNs) to detect coding patterns and authorship attributes, remove comments and dead code during the normalizing the ingested source code, and the ingestion of source code includes collecting code from both public and private repositories, generate the vector embeddings using a neural network model trained on a large corpus of code, generate a report that summarizes results of the attributing the source code, including specific confidence levels for the code attribution, and perform robustness testing by creating and evaluating multiple code variants to ensure attribution accuracy under different code modifications.

According to another aspect of the present invention, a method is provided for enhancing source code verification, including ingesting source code from multiple sources, normalizing the ingested source code by employing abstract syntax trees (ASTs) to adjust syntactic formats, transforming the ingested source code into vector embeddings capable of depicting syntactic and semantic characteristics, generating unique code identifiers from the vector embeddings, comparing the code identifiers within a vector database to ascertain potential source similarities and verify originality of the source code, and enhancing code integrity by generating corrective code modifications based on results of the comparing the code identifiers.

According to additional embodiments of the present invention, the method further includes implementing an iterative normalization process during the normalizing the ingested source code to progressively refine code structure, the ingested source code including both legacy and contemporary coding frameworks, and enhancing verification of code originality and source by analyzing the unique code identifiers with a graph neural network (GNN) to identify complex coding patterns and authorship traits.

According to another aspect of the present invention, a system is provided for enhancing source code verification, including a processor device and a memory storing instructions that, when executed by the processor device, cause the system to ingest source code from multiple sources, normalize the ingested source code by employing abstract syntax trees (ASTs) to adjust syntactic formats, transform the ingested source code into vector embeddings capable of depicting syntactic and semantic characteristics, generate unique code identifiers from the vector embeddings, compare the code identifiers within a vector database to ascertain potential source similarities and verify originality of the source code, and enhance code integrity by generating corrective code modifications based on results of the comparing the code identifiers.

According to additional embodiments of the present invention, the system stores instructions to implement an iterative normalization process during the normalizing the ingested source code to progressively refine code structure, the ingested source code including both legacy and contemporary coding frameworks.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a method for creating a comprehensive knowledge base and performing code attribution analysis and recommendation generation, in accordance with embodiments of the present invention;

FIG. 3 is a diagram illustratively depicting a method for attributing source code, providing feedback for code improvement, and automatically performing corrective actions, in accordance with embodiments of the present invention;

FIG. 4 is a diagram illustratively depicting a system and method for creating a comprehensive knowledge base, performing code attribution analysis and recommendation generation, and automatically performing corrective actions for various real-world applications and environments, in accordance with embodiments of the present invention;

FIG. 5 is a diagram illustratively depicting a method for code attribution, complexity measurement, and alternative code recommendation generation, in accordance with embodiments of the present invention;

FIG. 6 is a diagram illustratively depicting a system and method for identifying and attributing source code using abstract syntax trees (ASTs), vector embeddings, and graph neural networks (GNNs) to determine coding patterns and authorship, verify code originality, provide feedback and perform automatic corrective actions for enhancing code quality and maintainability, in accordance with embodiments of the present invention;

FIG. 7 is a diagram illustratively depicting a method including exemplary pseudocode for creating a comprehensive knowledge base and performing code attribution analysis and recommendation generation, in accordance with embodiments of the present invention; and

FIG. 8 is a diagram illustratively depicting an exemplary processing system for improved, source code verification, attribution, and execution of automatic corrective actions, in accordance with embodiments of the present invention.

### DETAILED DESCRIPTION

The present invention pertains to the field of software development and code analysis, in particular focusing on the verification and attribution of source code using advanced semantic analysis and machine learning techniques.

In accordance with embodiments of the present invention, systems and methods are provided for verifying and attributing source code using advanced semantic analysis and machine learning techniques. This innovative system can efficiently identify and attribute both human-authored and AI-generated source code by analyzing the code's syntactic and semantic features. The present invention can integrate sophisticated neural network models and graph neural networks (GNNs), trained on a diverse corpus of code, to generate unique vector embeddings and fingerprints. These embeddings can capture deep semantic relationships within the code, enabling the system to perform complex pattern recognition and similarity detection across various programming languages and coding styles.

In various embodiments, the invention can be utilized to ensure the originality and proper attribution of source code, addressing the significant current challenges of distinguishing between human-authored and AI-generated code and managing cross-language codebases. The system can begin by ingesting source code from various repositories, including public and private sources. This code can then be normalized using abstract syntax trees (ASTs), which can standardize the syntactic structure, removing comments and dead code. The normalized code can be converted into vector embeddings that encapsulate both syntactic and semantic features, facilitating advanced pattern recognition.

The present invention can further process these embeddings to generate unique fingerprints for each code snippet. These fingerprints can be analyzed using GNNs to detect intricate coding patterns and authorship attributes. By comparing these fingerprints against a comprehensive vector database, the system can verify the originality and source of the code, identifying potential matches and prior art. This comparison can be enhanced by advanced similarity search algorithms such as, for example, cosine similarity or Euclidean distance.

Moreover, the system can perform robustness testing by iteratively creating and evaluating multiple code variants in real-time (or any selected time period) to ensure attribution accuracy under different modifications. It can generate comprehensive reports summarizing the findings, confidence levels, provide actionable feedback and alternative code suggestions to developers, and/or automatically implement alternative code suggestions for improving code robustness, maintainability, and security, in accordance with aspects of the present invention.

The present invention can incorporate adaptive learning mechanisms, continuously refining and enhancing its accuracy based on the feedback from the analysis and robustness testing phases. This adaptive learning ensures that the system remains effective and relevant in a rapidly evolving coding landscape. Additionally, the system can build Federated Models using insights gained from previous steps, providing comprehensive educational guidance and improving the overall quality and security of the code. The present invention offers a robust and scalable solution for code verification, attribution, and/or implementation of automatic corrective actions, thus providing significant benefits in maintaining intellectual property integrity, enhancing code quality, and supporting developers in adopting best coding practices, in accordance with aspects of the present invention.

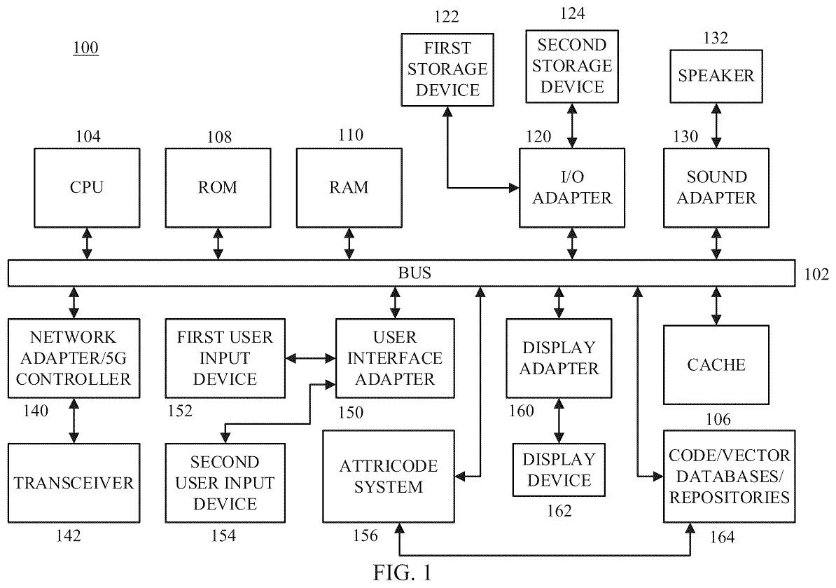

Referring now to the drawings in which like numerals represent the same or similar elements and initially to FIG. 1, an exemplary processing system 100, to which the present principles may be applied, is illustratively depicted in accordance with embodiments of the present invention.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a semantic search engine 164 for text and/or image processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. A system for identifying and attributing source code using abstract syntax trees (ASTs), vector embeddings, and graph neural networks (GNNs) to determine coding patterns and authorship, verify code originality, provide feedback and perform automatic corrective actions for enhancing code quality and maintainability (ATTRICODE system) 156 can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The ATTRICODE system 156 can process received input, and can obtain data from any of a plurality of sources, including code/vector databases/repositories 164 which be operatively connected to the system 100 for use for identifying and attributing source code using abstract syntax trees (ASTs), vector embeddings, and graph neural networks (GNNs) to determine coding patterns and authorship, verify code originality, provide feedback and perform automatic corrective actions for enhancing code quality and maintainability, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

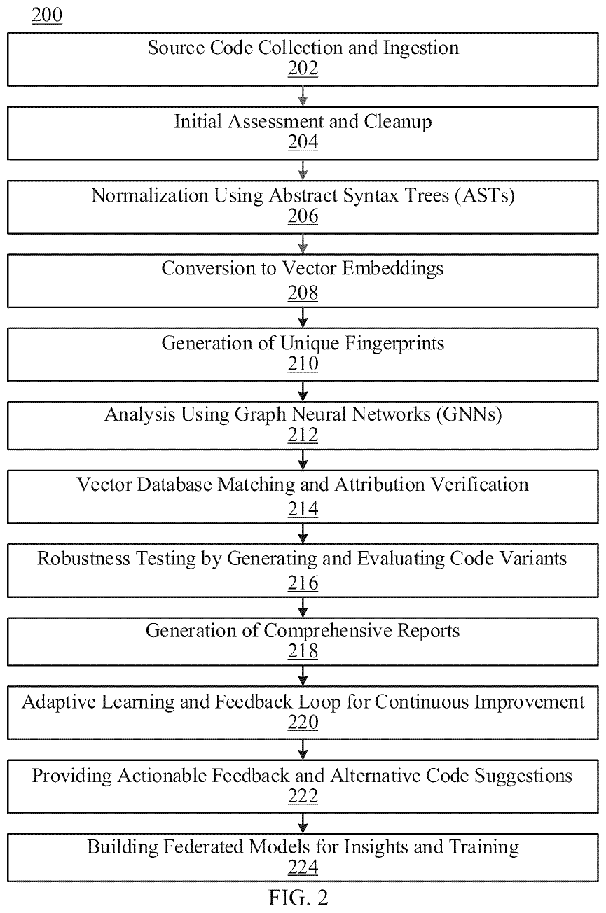

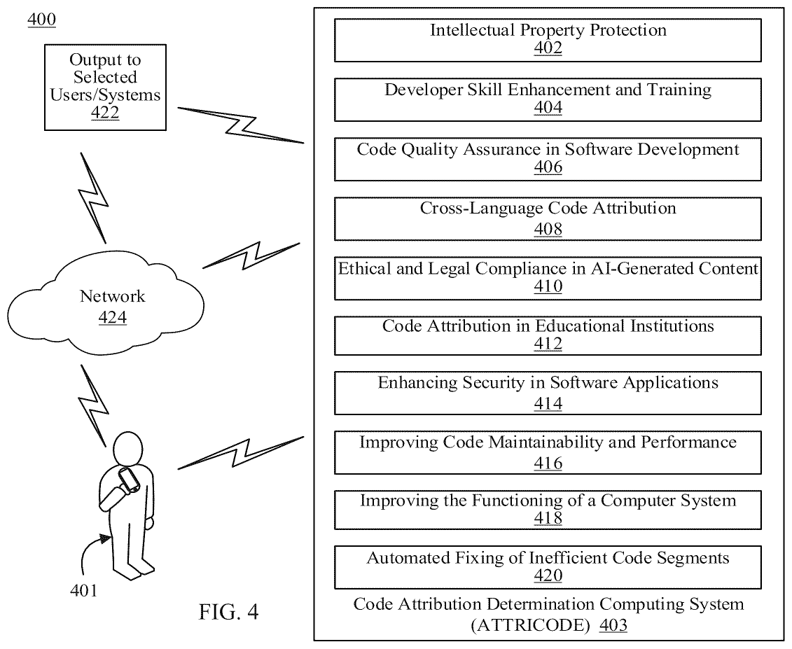

Moreover, it is to be appreciated that systems 400, 600, and 800, described below with respect to FIGS. 4, 6, and 8, respectively, are systems for implementing respective embodiments of the present invention. Part or all of processing system 100 may be implemented in one or more of the elements of systems 400, 600, and 800, in accordance with aspects of the present invention. Further, it is to be appreciated that processing system 100 may perform at least part of the methods described herein including, for example, at least part of methods 200, 300, 400, 500, 600, and 700, described below with respect to FIGS. 2, 3, 4, 5, 6, and 7, respectively. Similarly, part or all of systems 400, 600, and 800 may be used to perform at least part of methods 200, 300, 400, 500, 600, and 700 of FIGS. 2, 3, 4, 5, 6, and 7, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a method 200 for creating a comprehensive knowledge base and performing code attribution analysis and recommendation generation, is illustratively depicted in accordance with embodiments of the present invention.

In various embodiments, in block 202, source code can be collected from various repositories, including GitHub, Bitbucket, GitLab, and internal private repositories maintained by organizations. This step can involve harvesting the source code, which can then be standardized to a common format using Abstract Syntax Trees (ASTs). The AST generation can occur even if there are syntax errors and can be dependency-free, allowing its runtime library to be embedded in any application. The collected code can include various programming languages and formats to ensure a comprehensive dataset. The standardization process can include normalizing the code structure, removing comments and dead code, and harmonizing the embeddings to ensure a consistent format for subsequent analysis. This step can further include creating a representative sample of both human-authored and AI-generated code, providing a foundation for subsequent analysis. The normalized code can then be stored in a centralized database, ready for further processing.

In block 204, the ingested source code can undergo an initial assessment and cleanup process. This step can involve identifying any corrupted files or unsupported formats that may need to be excluded from further analysis. The cleanup operation can remove non-code files, comments, and extraneous data that may skew the normalization process. This ensures that the dataset is clean and suitable for further processing, focusing on the functional aspects of the code. In block 206, the cleaned source code can be normalized using Abstract Syntax Trees (ASTs). This process can involve parsing the source code to create a tree representation that captures the syntactic structure of the code. ASTs can be generated even if there are syntax errors, ensuring that all available code can be analyzed. The normalization process can also standardize the code structure by unifying indentation, spacing, and brace styles, and standardizing naming conventions where possible. Comments and dead code can be removed to focus on the functional aspects of the code.

In block 208, the normalized code (e.g., represented by ASTs) can be converted into vector embeddings. These embeddings represent the syntactic and semantic features of the code in a multi-dimensional space. Techniques such as tokenization, indexing, and the use of neural networks can be employed to capture deep semantic relationships within the code. In various embodiments, these embeddings can capture both syntactic and semantic features of the code, allowing for sophisticated pattern recognition and similarity detection. The conversion process can utilize neural network models trained on comparatively large corpuses of code, transforming the hierarchical structure of the ASTs into a numerical format that can be accurately and efficiently processed by machine learning algorithms. For instance, the Abstract Syntax Trees (ASTs) can be transformed into numerical vectors that encode the structural and functional aspects of the code. This high-dimensional representation can be utilized effectively for advanced pattern recognition and similarity detection across different code snippets, facilitating a robust foundation for subsequent analysis.

In block 210, unique fingerprints can be derived and generated from the vector embeddings. These fingerprints can encapsulate the core attributes of the code, creating a distinctive identifiers and/or a summary that can be easily recognized and compared by the computing system, which facilitate comparison and analysis in real-time. The generation of fingerprints can involve hashing or other encoding techniques to ensure that each piece of code has a unique and recognizable representation. These fingerprints can be used to track the code across different repositories and versions, enabling precise attribution. In block 212, the fingerprints generated from the vector embeddings can be analyzed using Graph Neural Networks (GNNs). GNNs can leverage the graph-based structure of the fingerprints to detect complex patterns and similarities for code attribution. The GNNs can learn from the connectivity patterns and features of the codebase, identifying coding styles and authorship attributes with high accuracy. GNNs can leverage the graph-based structure of the fingerprints to detect complex coding patterns and authorship attributes. This analysis can reveal deep insights into the coding style, structural nuances, and potential authors of the code. By comparing the fingerprints within a graph framework, GNNs can identify relationships and similarities that traditional linear models are not able to identify, providing an improved and robust method for code attribution. This step can be particularly useful for distinguishing between human and AI-generated code, providing a reliable method for code attribution.

In block 214, the fingerprints and the vector embeddings can be compared against a vector database containing a vast array of code vectors. This comparison can be conducted using similarity search algorithms such as cosine similarity or Euclidean distance to identify potential matches. The attribution verification process can confirm the source and originality of the code by thoroughly examining the identified matches. The vector database can be populated with code from various sources, providing a comprehensive reference for attribution. The comparison process can verify the originality of the code and identify possible prior art or reused code segments, ensuring accurate code attribution. This step ensures that the code attribution is accurate and compliant with legal and ethical standards, safeguarding intellectual property rights and maintaining the integrity of the software development process.

In block 216, robustness testing can be performed by creating and evaluating multiple code variants. This step can include automatically creating one or more altered versions of the code with specific transformations, such as renaming variables, altering code structure, or modifying syntax. The system can then determine whether it can still trace these variants back to the original source (e.g., whether the attribution accuracy is maintained under these variations), effectively measuring the robustness of its attribution mechanisms. Robustness testing ensures that the attribution methods are resilient to common coding changes and manipulations, providing confidence and improvements in the system's reliability.

In various embodiments, in block 216, the testing methodology can involve using data from the same bucket of the knowledge base. This can include original data from The Stack corpus, which serves as the baseline for robustness testing. In some embodiments, variations from the original data can be created, such as different whitespace, layout, and comments; variations in identifiers, literals, types, whitespace, layout, and comments; changes, additions, or removals of statements, in addition to variations in identifiers, literals, types, whitespace, layout, and comments; and variations in syntax, where code fragments that perform the same computation are implemented using different syntactic variants. Additionally, unseen data from other code corpora or from other projects can be used to test the system's ability to handle previously unseen data. Testing data can also be sourced from market-available datasets and can be analyzed at different granularities, including whole files, full classes, single methods or functions, and just a couple of lines (part of a function). Testing scenarios can include randomly sampling code snippets from the original dataset with different data granularities to see if the snippets can be identified correctly; testing codes from other corpora or projects as unseen code snippets to see if they can be identified properly; and similar languages testing, where code snippets from the original dataset are rewritten in a similar language (e.g., TypeScript vs. JavaScript) to see if they can be identified correctly. This comprehensive testing methodology ensures that the system's attribution mechanisms are robust and reliable, capable of handling various code transformations and maintaining accuracy across different coding scenarios, in accordance with aspects of the present invention.

In block 218, a comprehensive report can be generated that summarizes the findings and providing details on the system's confidence levels in attributing each code variant. This report can include detailed analyses of the code's origin, authorship, and structural characteristics. It can also provide confidence metrics that indicate the reliability of the attribution results. This report can be used by developers, project managers, and legal teams to make informed decisions regarding code usage and intellectual property, offering transparency and accountability in the development process. This report can include insights into the attribution accuracy, provide recommendations which highlight areas where the system can be further improved, and/or perform automatic corrective actions responsive to the identified areas where the system can be further improved, in accordance with aspects of the present invention.

In block 220, the system can incorporate findings from the attribution and robustness testing phases back into the process through adaptive learning. This step can involve collecting data on success rates, confidence levels, and types of code variations encountered during testing. The system can analyze this aggregated data to identify patterns or common characteristics in cases of both success and failure. Based on this analysis, the attribution algorithms can be adjusted, which can include, for example, retraining machine learning models with new data, updating heuristic rules, and improving code variation generation algorithms. This continuous feedback loop ensures that the system remains accurate and adaptable to new coding practices, providing iterative ongoing improvement and refinement. In block 222, developers can receive from the system actionable feedback and alternative code suggestions based on the system's comprehensive analysis. This step involves providing developers with practical recommendations for improving code robustness, maintainability, and security. The system can analyze the attributed code and suggest alternative implementations that might offer better performance, maintainability, or security. These suggestions can be tailored to the specific needs of the developers, supporting continuous learning and skill development. This feature enhances the system's utility by not only identifying and attributing code but also guiding developers towards best practices and improved coding standards.

In block 224, the system can build one or more Federated Models (FMs) using the insights gained from the previous steps. These models can be trained using features discovered during the attribution and analysis processes, such as coding patterns, authorship attributes, and similarity metrics. The Federated Model (FM) can then provide comprehensive insights that educate and/or remediate, offering explanations for the recommendations and helping developers understand and adopt best practices. This step can be utilized to enhance code quality and developer skills through educated insights and recommendations, ensuring that the system remains relevant and effective in a rapidly evolving technological landscape, in accordance with aspects of the present invention. The method 200 provides a comprehensive and systematic approach to verifying, differentiating, and attributing both human-authored and AI-generated source code. The process includes source code collection, initial assessment and cleanup, normalization using ASTs, conversion to vector embeddings, fingerprint generation, GNN analysis, comparison against a vector database, robustness testing, generation of comprehensive reports, adaptive learning, providing actionable feedback, and building Federated Models. Each step is meticulously detailed to ensure accuracy, robustness, and compliance with intellectual property standards, providing a reliable and practical solution for code attribution and quality improvement, in accordance with aspects of the present invention.

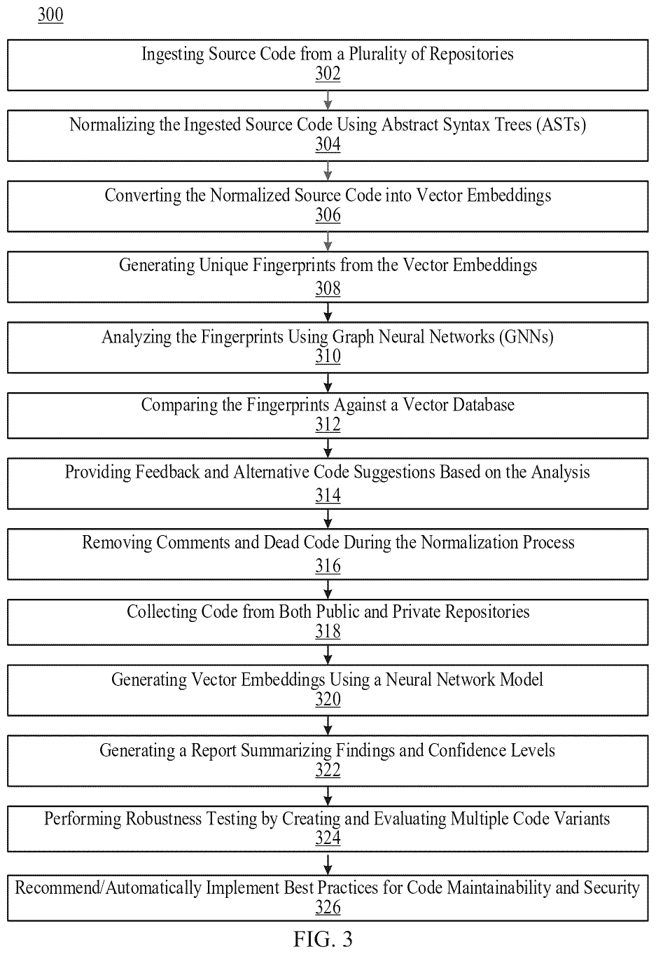

Referring now to FIG. 3, a method 300 for attributing source code, providing feedback for code improvement, and automatically performing corrective actions, is illustratively depicted in accordance with embodiments of the present invention.

In various embodiments, in block 302, source code can be ingested from various repositories, including but not limited to public repositories such as GitHub, Bitbucket, and private repositories that organizations may maintain internally. This step can involve accessing the repositories through APIs or direct database queries to gather code samples. The ingested code can include diverse programming languages and formats, ensuring a comprehensive dataset for subsequent analysis. The ingestion process can also handle different versions of code, providing a historical perspective on code evolution. In block 304, the ingested source code can be normalized using Abstract Syntax Trees (ASTs). This normalization process can involve parsing the source code to create a tree representation that captures the syntactic structure of the code. The ASTs can be generated even if there are syntax errors, ensuring that all available code can be analyzed. During normalization, comments and dead code can be removed to focus on the functional aspects of the code. The resulting ASTs can be standardized across different programming languages to provide a uniform basis for further processing.

In block 306, the normalized source code represented by ASTs can be converted into vector embeddings. This conversion can be achieved using neural network models trained on large corpuses of code. The vector embeddings can capture both syntactic and semantic features of the code, allowing for sophisticated pattern recognition and similarity detection. These embeddings transform the hierarchical structure of the ASTs into a numerical format that can be easily processed by machine learning algorithms. In block 308, unique fingerprints can be generated from the vector embeddings. These fingerprints can encapsulate the core attributes of the code, creating distinctive identifiers that facilitate comparison and analysis. The generation of fingerprints can involve hashing or other encoding techniques to ensure that each piece of code has a unique and recognizable representation. These fingerprints can be used to track the code across different repositories and versions, enabling precise attribution. In block 310, the fingerprints generated from the vector embeddings can be analyzed using Graph Neural Networks (GNNs). GNNs can leverage the graph-based structure of the fingerprints to detect complex coding patterns and authorship attributes. This analysis can reveal deep insights into the coding style, structural nuances, and potential authors of the code. By comparing the fingerprints within a graph framework, GNNs can identify relationships and similarities that traditional linear models might miss.

In block 312, the fingerprints can be compared against a vector database containing a vast array of code vectors. This comparison can be conducted using similarity search algorithms such as cosine similarity or Euclidean distance to identify potential matches. The vector database can be populated with code from various sources, providing a comprehensive reference for attribution. The comparison process can verify the originality of the code and identify possible prior art or reused code segments. In block 314, feedback and alternative code suggestions can be provided based on the analysis. This feedback can include recommendations for improving code robustness, maintainability, and security. The system can suggest alternative implementations that align better with best practices or coding standards. These suggestions can be tailored to the specific context and needs of the developers, offering practical guidance to enhance the quality and integrity of the code.

In block 316, comments and dead code can be removed during the normalization process. This step ensures that the analysis focuses on the functional aspects of the code, excluding non-executable elements that might skew the results. The removal process can be automated using parsing tools that identify and exclude comments, redundant code, and other non-functional elements from the ASTs. In block 318, code can be collected from both public and private repositories. This step ensures that the dataset is comprehensive and representative of diverse coding environments. Public repositories like GitHub and Bitbucket provide access to a wide range of open-source projects, while private repositories offer insights into proprietary codebases. The inclusion of both types of repositories enhances the robustness and relevance of the analysis. In block 320, the vector embeddings can be generated using a neural network model trained on a large corpus of code. This model can be designed to capture the intricate syntactic and semantic features of the code, providing rich embeddings that facilitate detailed analysis. The training corpus can include code from multiple programming languages and domains, ensuring that the model is versatile and capable of handling diverse coding scenarios.

In block 322, a report can be generated summarizing the findings and confidence levels in code attribution. This report can include detailed analyses of the code's origin, authorship, and structural characteristics. It can also provide confidence metrics that indicate the reliability of the attribution results. This report can be used by developers, project managers, and legal teams to make informed decisions regarding code usage and intellectual property. In block 324, robustness testing can be performed by creating and evaluating multiple code variants. This testing can involve generating modified versions of the code, such as renaming variables, altering code structure, or modifying syntax. The system can then assess whether the attribution accuracy is maintained under these variations. Robustness testing ensures that the attribution methods are resilient to common coding changes and manipulations. In block 326, best practices for code maintainability and security can be recommended. These recommendations can be based on the analysis and insights generated throughout the process. Best practices can include coding standards, design patterns, and security guidelines that enhance the quality and integrity of the code. By following these recommendations, developers can produce code that is not only functional but also robust, maintainable, and secure, in accordance with aspects of the present invention.

Referring now to FIG. 4, a system and method 400 for creating a comprehensive knowledge base, performing code attribution analysis and recommendation generation, and automatically performing corrective actions for various real-world applications and environments (ATTRICODE), is illustratively depicted in accordance with embodiments of the present invention.

In various embodiments, a user 401, such as a data scientist, developer, or system administrator, can utilize the ATTRICODE system and method for various tasks. For example, the user can make requests to the ATTRICODE system to analyze, attribute, and optimize code. The user can access the system remotely via network connections such as LAN, WAN, or the Internet, or directly if the system is installed on their device. The interactions can include submitting code for analysis, receiving feedback and recommendations, and implementing suggested improvements.

In block 403, various exemplary functionalities of the overall ATTRICODE system are depicted, noting that these exemplary functionalities are presented for ease of illustration, noting that various additional functionalities can be performed by the ATTRICODE system and method of the present invention in accordance with various aspects of the present invention. Block 403 illustrates several key processes and components to attribute code accurately and provide actionable insights based on the analysis. The methodology can involve collecting code, ingesting and normalizing the code, embedding the code into vectors, performing fingerprinting and graph neural network (GNN) analysis, verifying attributions with vector databases, conducting robustness testing, applying adaptive learning, and generating implementation recommendations.

In block 402, the system can be utilized for intellectual property protection by verifying the originality of source code and ensuring proper attribution to rightful creators. This application can involve using the system to identify whether a piece of code has been reused without authorization, thus safeguarding against potential IP violations. By generating unique fingerprints for each code snippet and comparing them against a comprehensive vector database, the system can accurately attribute code, providing legal and ethical compliance in the software industry. This can protect intellectual property by accurately attributing code and preventing unauthorized reuse.

In block 404, the system can support developer skill enhancement and training by providing actionable feedback and alternative code suggestions based on comprehensive analysis. This application can involve analyzing the attributed code to recommend best practices, improving code robustness, maintainability, and security. The system can also generate detailed reports that highlight areas for improvement, helping developers to continuously learn and adopt better coding standards, ultimately enhancing their skills and productivity. This application can involve analyzing attributed code to recommend best practices, improving code robustness, maintainability, and security. Detailed reports highlight areas for improvement, helping developers to continuously learn and adopt better coding standards, enhancing developer skills and productivity through guided feedback and recommendations.

In block 406, the system can be applied to code quality assurance in software development processes. This application can involve integrating the system into continuous integration/continuous deployment (CI/CD) pipelines to monitor and verify the quality and originality of code being developed. By performing robust testing and providing insights into coding patterns and authorship, the system can ensure that the codebase remains clean, maintainable, and free from unauthorized reuse, thus maintaining high standards of code quality (e.g., during software development processes). In block 408, the system can be used for cross-language code attribution, addressing the challenge of identifying code that spans multiple programming languages. This application can involve analyzing code snippets written in different languages and accurately attributing their origins. The system's ability to normalize and analyze code using Abstract Syntax Trees (ASTs) and vector embeddings across various languages ensures that even mixed-language codebases can be effectively attributed, providing comprehensive coverage and code attribution across diverse coding environments.

In block 410, the system can be employed to ensure ethical and legal compliance in AI-generated content. This application can involve verifying the originality and attribution of code generated by AI models, ensuring that the generated content complies with intellectual property laws and ethical standards. By identifying the contributing source codes behind AI-generated content, the system can provide transparency and accountability, helping organizations to navigate the complex legal landscape of AI-assisted software development, and ensure compliance with intellectual property laws and ethical standards in AI-generated content. In block 412, the system can be used in educational institutions to verify the originality of student-submitted code and provide feedback for improvement. This application can involve integrating the system into academic environments to monitor and assess student assignments, ensuring that the submitted code is original and properly attributed. The system can also provide detailed feedback and alternative suggestions, helping students to learn best coding practices and improve their coding skills through guided instruction and analysis.

In block 414, the system can be utilized to enhance security in software applications by identifying and mitigating potential vulnerabilities in the code. This application can involve analyzing the codebase to detect patterns and practices that may pose security risks, providing recommendations for secure coding practices. By offering alternative code suggestions and highlighting security concerns, the system can help developers to produce more secure and resilient software applications, reducing the risk of security breaches and vulnerabilities. In block 416, the system can be used to improve the maintainability and performance of software codebases. This application can involve providing insights and recommendations for refactoring code to enhance its maintainability and performance. The system can analyze the code structure, identify areas that require optimization, and suggest alternative implementations that improve code efficiency and readability. By continuously monitoring and refining the code, the system can help maintain a high standard of code quality and performance.

In block 418, the system can be applied to improve the functioning of a computer system by optimizing software code for better performance and efficiency. This application can involve analyzing and refactoring code to enhance execution speed, reduce resource consumption, and improve overall system stability. The system can identify inefficient code segments, suggest optimized alternatives, and ensure that the code adheres to best practices for performance optimization. By implementing these improvements, the computer system can achieve higher performance, better resource management, and increased reliability in executing software applications.

In block 420, the system can further enhance computer functionality through the automated fixing of inefficient code segments. This embodiment involves the system autonomously identifying code that negatively impacts performance, such as memory leaks, redundant calculations, and inefficient loops. The system can use advanced machine learning models and heuristics to detect these inefficiencies and automatically generate optimized code replacements. These replacements can be tested in a sandbox environment to ensure they do not introduce new errors and that they improve performance metrics. Once validated, the optimized code can be integrated back into the application, streamlining the process of code optimization and reducing the manual effort required by developers. This automated approach not only improves the functioning of computer systems but also accelerates the development cycle and ensures consistent application of optimization techniques.

In block 422, the output from the system can be provided to selected users or systems. This output can include the results from blocks 402 through 420, such as code attribution reports, security recommendations, performance optimization suggestions, and educational feedback. The output can be delivered to various stakeholders, including developers, project managers, educational institutions, and legal teams, depending on their specific needs and use cases. The system can also integrate with other tools and platforms to automate the application of recommendations and streamline workflows. A network 424 represents various types of connections, including LAN (Local Area Network), WAN (Wide Area Network), and the Internet which can be employed for local and/or remote communication between users, user devices, and the ATTRICODE system. This network enables remote access to the ATTRICODE system, allowing users to submit code for analysis and receive recommendations from anywhere. The network connections can facilitate seamless integration with code repositories, databases, and other external systems, ensuring that the ATTRICODE system can operate efficiently and effectively in a distributed environment.

The system and method 400 illustrates various practical applications of the ATTRICODE system, demonstrating its versatility and effectiveness in various real-world scenarios. By addressing intellectual property protection, developer training, code quality assurance, cross-language attribution, ethical compliance, educational support, security enhancement, and code maintainability, the system provides comprehensive solutions that ensure accuracy, robustness, and compliance in code attribution and verification, in accordance with aspects of the present invention.

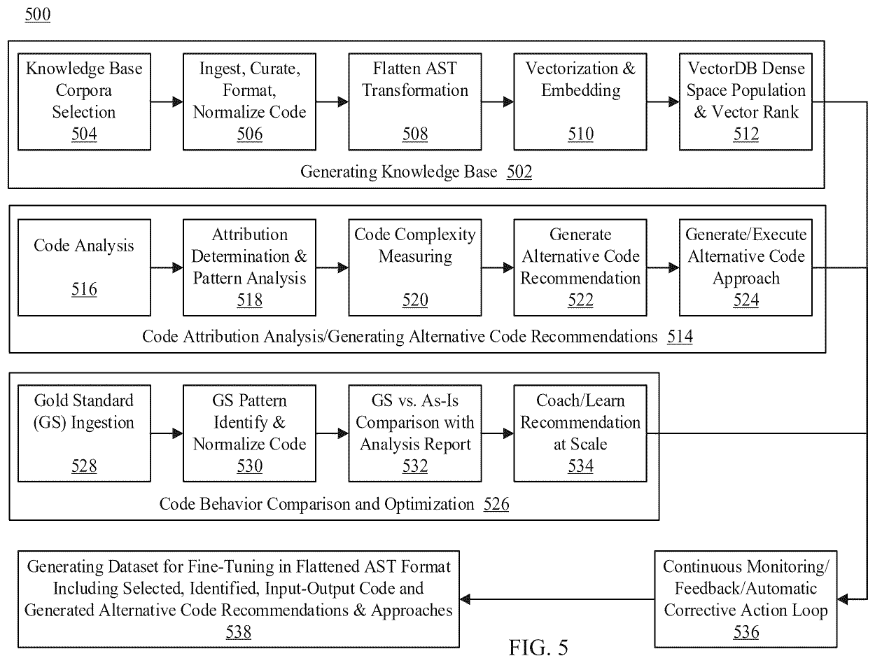

Referring now to FIG. 5, a method 500 for code attribution, complexity measurement, and alternative code recommendation generation, is illustratively depicted in accordance with embodiments of the present invention.

In various embodiments, in block 502, a high-level overall process for creating the knowledge base is illustratively depicted. This methodology can involve several detailed steps to ensure a comprehensive and robust foundation for code attribution and analysis. The process can include selecting a diverse and representative knowledge base corpora, ingesting and normalizing the code, transforming the code into a flattened Abstract Syntax Tree (AST) format, vectorizing and embedding the code, and populating a dense vector space for effective comparison and ranking.

In block 504, knowledge base corpora can be selected from various sources, including public repositories such as GitHub, proprietary codebases, and other large code datasets like The Stack. This step can involve identifying a diverse set of code samples across multiple programming languages and domains to ensure the knowledge base is comprehensive. The selection process can consider factors such as code quality, relevance, and representation of different coding styles and practices. In block 506, the selected code can be ingested, curated, formatted, and normalized. This step can involve parsing the source code to remove comments, dead code, and other non-functional elements. The code can then be standardized in terms of formatting and structure, ensuring consistency across different programming languages. The normalization process can include converting the code into a common format that can be further processed in subsequent steps.

In block 508, the normalized code can be transformed into a flattened Abstract Syntax Tree (AST) format. This transformation can involve parsing the code to generate ASTs that represent the syntactic structure of the code. The ASTs can then be flattened to create a linear representation that captures the hierarchical relationships within the code. This flattened format can facilitate more efficient vectorization and embedding processes. In block 510, the flattened ASTs can be converted into vector embeddings. This process can utilize advanced machine learning models, such as neural networks, to capture both syntactic and semantic features of the code. The embeddings can represent the code in a high-dimensional vector space, enabling sophisticated pattern recognition and similarity detection. This step can be crucial for creating a robust representation of the code that can be used for attribution and analysis.

In block 512, the vector embeddings can be populated into a dense vector space database (VectorDB) and ranked. This step can involve indexing the vector embeddings and performing similarity searches to identify and rank similar code snippets. The vector database can be continuously updated with new code samples, ensuring that it remains comprehensive and relevant. The ranking process can consider various factors, such as code uniqueness, complexity, and relevance to ensure accurate attribution and analysis. In block 514, the process for code attribution analysis and generating alternative code recommendations can be described. This methodology can involve analyzing the code to determine attribution, measuring code complexity, generating alternative code recommendations, and executing these recommendations to improve code quality and maintainability.

In block 516, code can be analyzed to determine its structural and functional characteristics. This step can involve parsing the code to identify key features, such as variable names, function calls, and control structures. The analysis can use various techniques, including static analysis, dynamic analysis, and heuristic-based methods, to gain a comprehensive understanding of the code's behavior and structure. In block 518, the system can determine the attribution of the code by analyzing patterns and comparing them with the knowledge base. This step can involve identifying unique coding styles, authorship attributes, and other distinguishing features. The analysis can use pattern recognition algorithms and machine learning models to match the code against the knowledge base and identify its likely origin and authorship.

In block 520, the system can measure the complexity of the code. This step can involve calculating various complexity metrics, such as cyclomatic complexity, Halstead complexity measures, and maintainability index. These metrics can provide insights into the code's complexity and help identify areas that may require optimization or refactoring. In block 522, the system can generate alternative code recommendations based on the complexity analysis and attribution determination. This step can involve suggesting modifications to improve code quality, performance, and maintainability. The recommendations can include refactoring suggestions, optimization techniques, and best practices for coding.

In block 524, the system can generate and execute alternative code approaches. This step can involve implementing the recommended changes and testing their impact on the code's performance and functionality. The system can use automated testing frameworks and sandbox environments to validate the changes and ensure they achieve the desired improvements. In block 526, the methodology for comparing code behavior across gold standards and organizational practices can be described. This process can involve ingesting gold standard code, identifying and normalizing patterns, comparing the current code against the gold standard, and providing coaching and learning recommendations at scale. In some embodiments, the system and method 500 can be utilized for verifying and attributing content (e.g., Artificial Intelligence (AI) generated, human generated, etc.) across various domains beyond software code, including, but not limited to lyrics, music, and written content, systems and methods of which can be respectively referred to as ATTRILYRICS, ATTRIMUSIC, and ATTRIWRITE.

In block 528, the system can ingest gold standard code samples. These samples can serve as benchmarks for code quality and best practices. The ingestion process can involve collecting code from reputable sources, such as industry standards, open-source projects, and proprietary benchmarks. An example gold standard, described hereinbelow with reference to Python (noting that the present invention is applicable to any code language), is as follows:
1. Avoid Magic Numbers and Strings
2. Implement proper error handling using try-except blocks to handle exceptions gracefully and provide meaningful error messages.
3. Naming method should follow PEP8 standard.
4. Avoid leaving function without logging,
5. Use type annotations to specify the types of function parameters and return values for improved clarity and tooling support.
6. Write functions that have a single responsibility, making them easier to understand, test, and maintain.
7. Import only the necessary functions, classes, or modules rather than importing everything from a module, to avoid namespace pollution and improve clarity.
8. Utilize context managers (with statement) for resource management, such as file I/O or database connections, to ensure proper cleanup.
9. Avoid using mutable objects (e.g., lists, dictionaries) as default arguments in function definitions, as they can lead to unexpected behavior
10. Every class should be well documented

In block 530, the system can identify patterns in the gold standard code and normalize them. This step can involve analyzing the gold standard code to extract common patterns, best practices, and coding styles. The normalization process can ensure that these patterns are represented consistently and can be compared against the current codebase. In block 532, the system can compare the current code against the gold standard and generate an analysis report. This comparison can highlight deviations from best practices, areas for improvement, and potential issues in the current code. The analysis report can provide detailed insights and recommendations for aligning the current code with the gold standard. In block 534, the system can provide coaching and learning recommendations at scale. This step can involve delivering personalized feedback and guidance to developers based on the comparison with the gold standard. The recommendations can help developers adopt best practices, improve code quality, and enhance their coding skills.

In block 536, the system can implement a continuous monitoring and feedback loop. This step can involve tracking the code's evolution over time, providing ongoing feedback, and applying automatic corrective actions as needed. The system can use machine learning models to continuously learn from new code samples and improve its recommendations and corrective actions. In block 538, the system can generate datasets for fine-tuning in a flattened AST format. This step can involve selecting and identifying input-output code pairs and generating alternative code recommendations. The datasets can be used to fine-tune machine learning models, allowing them to improve their performance and accuracy in code attribution and analysis. The process can support cross-language polarization and model improvements, ensuring the system remains effective across diverse coding environments, in accordance with aspects of the present invention.

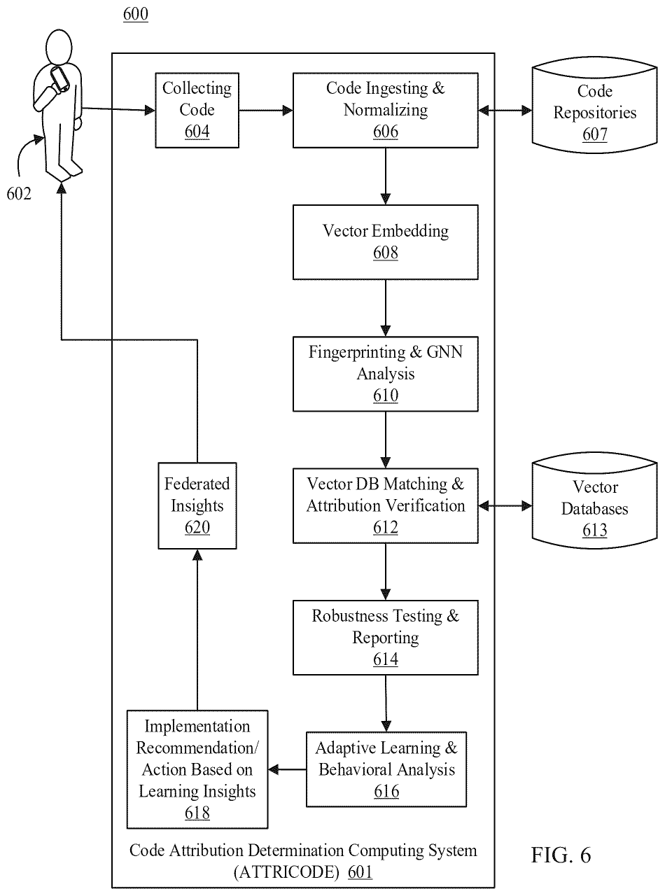

Referring now to FIG. 6, a system and method 600 for identifying and attributing source code using abstract syntax trees (ASTs), vector embeddings, and graph neural networks (GNNs) to determine coding patterns and authorship, verify code originality, provide feedback and perform automatic corrective actions for enhancing code quality and maintainability, is illustratively depicted in accordance with embodiments of the present invention.

In various embodiments, in block 601, the overall ATTRICODE system for code attribution determination is illustratively depicted in a high-level view. This system can encompass several key processes and components designed to attribute code accurately and provide actionable insights based on the analysis. The methodology can involve collecting code, ingesting and normalizing the code, embedding the code into vectors, performing fingerprinting and graph neural network (GNN) analysis, verifying attributions with vector databases, conducting robustness testing, applying adaptive learning, and generating implementation recommendations. A user 602 (e.g., data scientist) can interact with the ATTRICODE system using any of a plurality of user devices. This interaction can involve collecting code from various repositories, submitting it to the system for analysis, and receiving insights and recommendations. The data scientist can play a role in overseeing the code attribution process and ensuring that the results are effectively utilized. The data scientist can also use the system's feedback to improve coding practices and implement recommended changes.

In block 604, code can be collected from various sources, including public and private repositories. This step can involve harvesting code samples from platforms such as GitHub, Bitbucket, and proprietary codebases. The collected code serves as the raw input for subsequent analysis and processing steps. This process can include identifying relevant projects, pulling the latest versions of code, and organizing the code into a standardized structure for ingestion. In block 606, the collected code can be ingested and normalized. This step can involve parsing the code to remove comments, dead code, and other non-functional elements. The code can then be standardized in terms of formatting and structure, ensuring consistency across different programming languages. The normalization process can prepare the code for further analysis by converting it into a common format. The ingestion process can also handle code dependencies, ensuring that all necessary components are included for accurate analysis.

In block 607, code repositories can be accessed to retrieve source code. These repositories can include platforms like GitHub, Bitbucket, and other code storage systems. The repositories provide the raw code that can be ingested and analyzed by the system. The system can be configured to automatically sync with these repositories, ensuring that the most up-to-date code is always available for analysis. In block 608, the normalized code can be embedded into vectors. This process can utilize advanced machine learning models, such as neural networks, to capture both syntactic and semantic features of the code. The embeddings represent the code in a high-dimensional vector space, enabling sophisticated pattern recognition and similarity detection. Techniques such as tokenization, sequence embedding, and contextual embedding can be employed to create rich vector representations of the code.

In block 610, the system can generate unique fingerprints for the vector embeddings and perform GNN analysis. This step can involve creating distinct identifiers for each code snippet based on its vector representation. The GNN analysis can then detect coding patterns and authorship attributes by analyzing the relationships between different code fragments. This process can include constructing a graph structure where nodes represent code components and edges represent syntactic or semantic connections, allowing the GNN to learn and identify complex patterns. In block 612, the vector embeddings can be matched against a vector database to verify code attributions. This step can involve querying the vector database to identify potential matches and confirm the origin of the code. The verification process can ensure that the code is correctly attributed to its rightful creators. The vector database can be populated with a wide range of code samples, allowing for comprehensive comparison and accurate attribution.

In block 613, vector databases can be used to store and manage vector embeddings of code. These databases can facilitate efficient searching and matching of code vectors, enabling accurate attribution and analysis. The vector databases can be continuously updated with new code samples and fingerprints, ensuring that they remain current and comprehensive. The databases can also support various querying techniques, such as similarity search and nearest neighbor search, to efficiently find matching code vectors. In block 614, the system can conduct robustness testing and generate reports. This step can involve creating and evaluating multiple code variants to ensure that the attribution remains accurate under different code modifications. The system can generate comprehensive reports summarizing the findings and confidence levels in code attribution. Robustness testing can include scenarios such as variable renaming, code restructuring, and obfuscation to assess the system's ability to maintain accurate attribution.

In block 616, adaptive learning and behavioral analysis can be applied to refine the system's performance. This step can involve using feedback from previous analyses to improve the accuracy and robustness of the attribution algorithms. The system can continuously learn from new data, adapting to evolving coding practices and patterns. This process can include retraining machine learning models, updating heuristic rules, and incorporating new patterns observed in the codebase. In block 618, the system can provide implementation recommendations and actions based on the insights gained from the analysis. This step can involve suggesting modifications to improve code quality, performance, and maintainability. The recommendations can be tailored to address specific issues identified during the analysis, helping developers to enhance their code. The system can also provide alternative code suggestions, highlight best practices, and guide developers in refactoring their code for better efficiency and readability.

In block 620, federated insights can be generated from the aggregated data. This step can involve compiling insights from multiple sources and analyses to provide a comprehensive view of coding patterns and practices. The federated insights can help developers understand broader trends and make informed decisions based on the collective knowledge. This can include identifying common coding challenges, recognizing effective coding techniques, and leveraging community-driven insights to improve individual and team coding practices. The system and method 600 illustratively depicts various blocks and processes involved in the ATTRICODE system, providing a comprehensive overview of the system's functionality and methodology for accurate code attribution and actionable insights. By incorporating advanced techniques such as vector embedding, GNN analysis, and adaptive learning, the ATTRICODE system offers a robust and scalable solution for code attribution, quality improvement, and developer support, in accordance with aspects of the present invention.

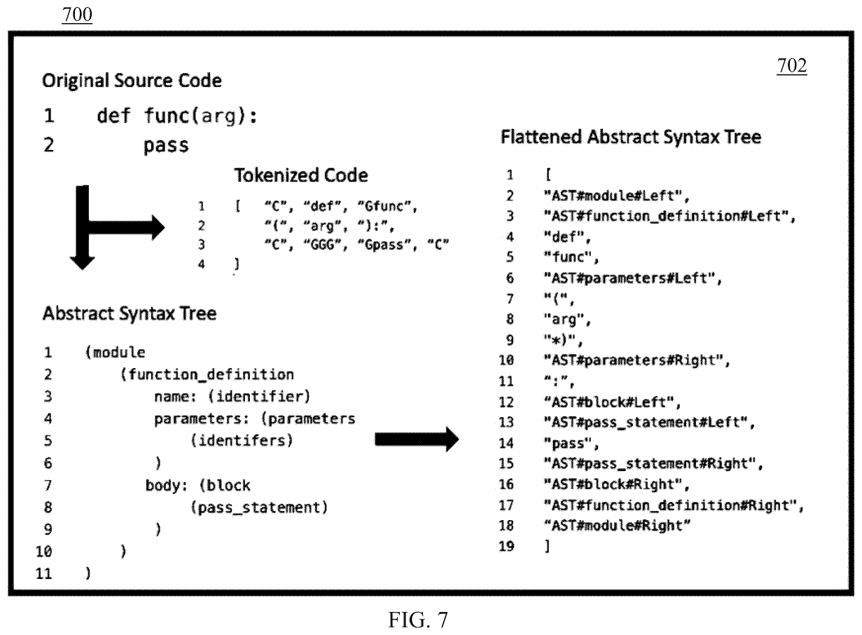

Referring now to FIG. 7, a method 700 including a depiction of exemplary pseudocode 702 for creating a comprehensive knowledge base and performing code attribution analysis and recommendation generation, is illustratively depicted in accordance with embodiments of the present invention. The method 700 can include tokenizing source code, generating an abstract syntax tree (AST), and creating a flattened AST for analysis, and the pseudocode 702 can be utilized for executing various processes in the ATTRICODE system for the purposes of code attribution and analysis.

In this illustrative example, the pseudocode 702 can be utilized for tokenization and AST tokenization. The original source code snippet is a simple Python function definition, and a first step in processing the source code can be tokenization, where the code is broken down into its constituent tokens. This step can convert the original source code into a list of tokens (e.g., [“C”, “def”, “Gfunc”, “(“, “arg”,”):”, “C”, “GGG”, “Gpass”, “C”]). The tokenized code can then be transformed into an AST, which represents the syntactic structure of the code in a hierarchical format. In this example, the AST includes nodes for the module, function definition, parameters, and body. The AST can then be flattened into a linear representation, which captures the hierarchical relationships in a sequential format. This flattened AST is more suitable for vectorization and embedding processes used by the ATTRICODE system.

The pseudocode 702 is particularly useful for various functionalities, including, for example:
Code Ingestion and Normalization: The original source code is ingested and normalized by the ATTRICODE system. During this process, the system performs tokenization to break the code into manageable units, which are then transformed into an AST to represent the code's syntactic structure.
Flattening the AST: The hierarchical AST is flattened into a linear format, making it suitable for further processing steps. This flattened representation is used to capture both syntactic and semantic features of the code, enabling sophisticated pattern recognition and analysis.
Vectorization and Embedding: The flattened AST is then vectorized and embedded into a high-dimensional vector space. This step allows the ATTRICODE system to create vector representations of the code that can be compared and analyzed using advanced machine learning models.
Fingerprinting and Analysis: The vector embeddings are used to generate unique fingerprints for the code snippets. These fingerprints are analyzed using graph neural networks (GNNs) to detect coding patterns and authorship attributes. The flattened AST facilitates efficient fingerprint generation and analysis by providing a structured yet linear representation of the code.
Attribution and Verification: The fingerprints generated from the flattened AST are compared against a vector database to verify the code's attribution. This step ensures that the code is correctly attributed to its rightful creators, and any unauthorized reuse is detected.
Robustness Testing: The system can perform robustness testing on the code by creating multiple variants of the flattened AST and evaluating the attribution accuracy. This process ensures that the attribution methods are resilient to common coding changes and manipulations.
Recommendations and Feedback: Based on the analysis, the system can provide feedback and recommendations for code improvement. The structured nature of the flattened AST allows the system to identify specific areas of the code that can be optimized or refactored.

The method 700 and pseudocode 702 can be utilized in various embodiments of the present invention to process source code, transforming it from its original form into a structured, analyzable format. This process enables accurate code attribution, robust analysis, actionable recommendations, and automatic corrective action performance for code improvement, in accordance with aspects of the present invention.

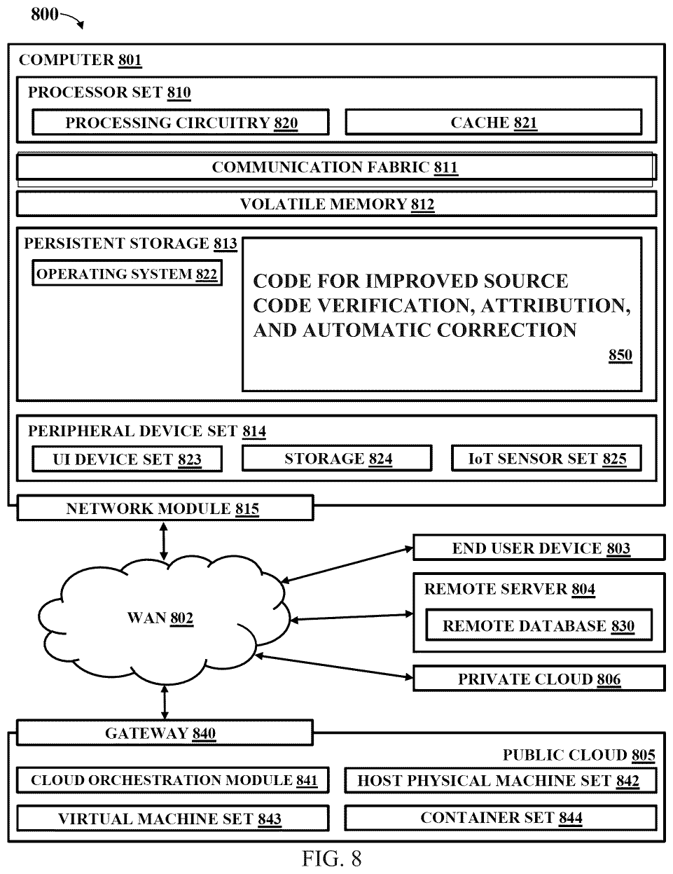

Referring now to FIG. 8, a system 800 for improved source code verification, attribution, and execution of automatic corrective actions, is illustratively depicted in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as code for improved source code verification, attribution, and execution of automatic corrective actions 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 200, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated. PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.”

In some computing environments, processor set 810 may be designed for working with qubits and performing quantum computing. Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths. VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801. PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices.

Operating system 822 may take several forms, such as various known proprietary operating systems or open source Portable Operating System Interface-type operating systems that employ a kernel. The code included in block 200 typically includes at least some of the computer code involved in performing the inventive methods. PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits.

In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices.

Computer readable program instructions for performing the inventive methods can typically be downloaded to computer 801 from an external computer or external storage device through a network adapter card or network interface included in network module 815. WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844.

It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for attributing source code, comprising:
ingesting source code from a plurality of repositories;
normalizing the ingested source code using abstract syntax trees (ASTs);
converting the normalized source code into vector embeddings that represent syntactic and semantic features of the source code;
generating unique fingerprints from the vector embeddings;
comparing the fingerprints against a vector database to identify potential matches and verify code attribution; and
generating feedback and alternative code suggestions based on the comparing the fingerprints.

2. The method of claim 1, further comprising analyzing the fingerprints using graph neural networks (GNNs) to detect coding patterns and authorship attributes.

3. The method of claim 1, further comprising removing comments and dead code during the normalizing the ingested source code, wherein the ingestion of source code includes collecting code from both public and private repositories.

4. The method of claim 1, wherein the vector embeddings are generated using a neural network model trained on a large corpus of code.

5. The method of claim 1, further comprising generating a report that summarizes results of the attributing the source code, including specific confidence levels for the code attribution.

6. The method of claim 1, further comprising performing robustness testing by creating and evaluating multiple code variants to ensure attribution accuracy under different code modifications.

7. The method of claim 1, wherein providing feedback and alternative code suggestions includes recommending best practices for code maintainability and security.

8. A system for attributing source code, comprising:
a processor device; and
a memory storing instructions that, when executed by the processor device, cause the system to:
ingest source code from a plurality of repositories;
normalize the ingested source code using abstract syntax trees (ASTs);
convert the normalized source code into vector embeddings that represent syntactic and semantic features of the source code;
generate unique fingerprints from the vector embeddings;
compare the fingerprints against a vector database to identify potential matches and verify code attribution; and
generate feedback and alternative code suggestions based on the comparing the fingerprints.

9. The system of claim 8, wherein the memory further stores instructions to analyze the fingerprints using graph neural networks (GNNs) to detect coding patterns and authorship attributes.

10. The system of claim 8, wherein the memory further stores instructions to remove comments and dead code during the normalizing the ingested source code, and the ingestion of source code includes collecting code from both public and private repositories.

11. The system of claim 8, wherein the memory further stores instructions to generate the vector embeddings using a neural network model trained on a large corpus of code.

12. The system of claim 8, wherein the memory further stores instructions to generate a report that summarizes results of the attributing the source code, including specific confidence levels for the code attribution.

13. The system of claim 8, wherein the memory further stores instructions to perform robustness testing by creating and evaluating multiple code variants to ensure attribution accuracy under different code modifications.

14. The system of claim 8, wherein the feedback and alternative code suggestions provided by the system include recommendations for best practices in code maintainability and security.

15. A computer program product for attributing source code, the computer program product comprising a computer readable storage medium having program instructions embodied therewith, the program instructions executable by a hardware processor to:
ingest source code from a plurality of repositories;
normalize the ingested source code using abstract syntax trees (ASTs);
convert the normalized source code into vector embeddings that represent syntactic and semantic features of the source code;
generate unique fingerprints from the vector embeddings;
compare the fingerprints against a vector database to identify potential matches and verify code attribution; and
generate feedback and alternative code suggestions based on the comparing the fingerprints.

16. The computer program product of claim 15, wherein the program instructions further comprise instructions to analyze the fingerprints using graph neural networks (GNNs) to detect coding patterns and authorship attributes.

17. The computer program product of claim 15, wherein the program instructions further comprise instructions to remove comments and dead code during the normalizing the ingested source code, and the ingestion of source code includes collecting code from both public and private repositories.

18. The computer program product of claim 15, wherein the program instructions further comprise instructions to generate the vector embeddings using a neural network model trained on a large corpus of code.

19. The computer program product of claim 15, wherein the program instructions further comprise instructions to generate a report that summarizes results of the attributing the source code, including specific confidence levels for the code attribution.

20. The computer program product of claim 15, wherein the program instructions further comprise instructions to perform robustness testing by creating and evaluating multiple code variants to ensure attribution accuracy under different code modifications.

21. A method for enhancing source code verification, comprising:
ingesting source code from multiple sources;
normalizing the ingested source code by employing abstract syntax trees (ASTs) to adjust syntactic formats;
transforming the ingested source code into vector embeddings capable of depicting syntactic and semantic characteristics;
generating unique code identifiers from the vector embeddings;
comparing the code identifiers within a vector database to ascertain potential source similarities and verify originality of the source code; and
enhancing code integrity by generating corrective code modifications based on results of the comparing the code identifiers.

22. The method of claim 21, further comprising implementing an iterative normalization process during the normalizing the ingested source code to progressively refine code structure, the ingested source code including both legacy and contemporary coding frameworks.

23. The method of claim 21, further comprising enhancing verification of code originality and source by analyzing the unique code identifiers with a graph neural network (GNN) to identify complex coding patterns and authorship traits.

24. A system for enhancing source code verification, comprising:
a processor device; and
a memory storing instructions that, when executed by the processor device, cause the system to:
ingest source code from multiple sources;
normalize the ingested source code by employing abstract syntax trees (ASTs) to adjust syntactic formats;
transform the ingested source code into vector embeddings capable of depicting syntactic and semantic characteristics;
generate unique code identifiers from the vector embeddings;
compare the code identifiers within a vector database to ascertain potential source similarities and verify originality of the source code; and
enhance code integrity by generating corrective code modifications based on results of the comparing the code identifiers.

25. The system of claim 24, wherein the memory further stores instructions to implement an iterative normalization process during the normalizing the ingested source code to progressively refine code structure, the ingested source code including both legacy and contemporary coding frameworks.
